(19) United States
(12) Patent Application Publication
(10) Pub. No.: US 2008/0165180 A1
(43) Pub. Date: Jul. 10, 2008

(54) METHOD FOR IMPROVING ELECTROMAGNETIC INTERFERENCE BY CHANGING DRIVING FREQUENCY AND LIQUID CRYSTAL DEVICE USING THE SAME

(76) Inventors: Sung-Hee LEE, Yongin-si (KR); Seoung-Bum Pyoun, Osan-si (KR)

Correspondence Address: F. CHAU & ASSOCIATES, LLC, 130 WOODBURY ROAD, WOODBURY, NY, 11797, US

(21) Appl. No.: 11/966,386

(22) Filed: Dec. 28, 2007

(30) Foreign Application Priority Data
Jan. 6, 2007 (KR) 10-2007-0001809

(51) Int. Cl. G09G 3/36; G09G 5/00

(52) U.S. Cl. 345/214; 345/87

(57) ABSTRACT

A liquid crystal display device includes a wireless communication module and a liquid crystal display module. The wireless communication module detects a communication frequency of a received wireless data signal and supplies an address mapped to the communication frequency. The liquid crystal display module includes a liquid crystal panel displaying a gray scale voltage in response to a gate driving signal and drives the liquid crystal panel by using a driving frequency mapped to the address.

### CROSS REFERENCE TO RELATED APPLICATION

This application claims priority to Korean Patent Application No. 10-2007-0001809, filed on Jan. 6, 2007, in the Korean Intellectual Property Office, the disclosure of which is incorporated by reference in its entirety herein.

### BACKGROUND OF THE INVENTION

1. Technical Field

The present disclosure relates to a liquid crystal display (LCD) device, and more particularly to a method for improving electromagnetic interference by changing a driving frequency and a liquid crystal display using same.

2. Discussion of Related Art

An LCD device can display images using light transmittance of a liquid crystal layer interposed between a first substrate and a second substrate. The light transmittance varies when a voltage is applied to electrodes of the two substrates facing each other to generate an electric field.

LCD devices typically have a slim profile, are light in weight, have a low power consumption and a high reliability. Accordingly, LCD devices are widely used in mobile devices such as Personal Digital Assistants (PDAs), mobile phones, and notebook computers.

The mobile devices may be equipped with a modem which can support various communication protocols. In notebook computers wireless communication may be supported via a wireless modem such as Wireless Local Area Network (W-LAN), Wireless Wide Area Network (W-WAN) and Wireless Personal Area Network (W-PAN), and a wired LAN modem.

When using W-WAN, mobile devices can communicate using different frequency bands according to various communication modes. For example, the communications modes may include Code Division Multiple Access (CDMA) 850, Global System for Mobile Communications (GSM) 850, Universal Mobile Telecommunications System (UMTS) 850, GSM 900, GSM 1800, and CDMA 1900.

However, when a mobile device operates in a frequency band selected according to the particular communication mode, the interaction between the selected communication frequency and the driving frequency of an LCD device of the mobile device can produce electromagnetic interference.

Thus, there is a need for method for improving the electromagnetic interference caused by the interaction between the communication frequency of a mobile device and the driving frequency of an LCD device and for an LCD device which improves electromagnetic interference.

### SUMMARY OF THE INVENTION

An exemplary embodiment of the present invention provides a liquid crystal display device (LCD) device including a wireless communication module and a LCD module. The wireless communication module detects a communication frequency of received wireless data signal and supplies an address mapped to the communication frequency. The LCD module has a liquid crystal panel for displaying a gray scale voltage in response to a gate driving signal and drives the liquid crystal panel by using a driving frequency mapped to the address.

The wireless communication module includes a communication frequency memory, an antenna, and a frequency detector. The communication frequency memory stores a communication frequency mapping table. The antenna receives the wireless data signal. The frequency detector detects the communication frequency of the wireless data signal and supplies an address mapped to the communication frequency by referencing the communication frequency mapping table.

The communication frequency mapping table may be a table which relates a plurality of communication frequency bands to corresponding addresses. The communication frequency memory may be an electrically erasable and programmable read only memory (EEPROM).

The LCD module may include driving frequency memory and a timing controller. The driving frequency memory stores a driving frequency mapping table. The timing controller obtains a driving frequency mapped to the address by referencing the driving frequency mapping table and generating a data driving clock and a gate driving clock using the driving frequency.

The driving frequency mapping table may be a table which relates the addresses to corresponding driving frequencies. A multiplying frequency of the driving frequency may be excluded from the communication frequency bands. The driving frequency memory may be an EEPROM.

The LCD device may further include a gate driver and a data driver. The gate driver supplies the gate driving signal to the liquid crystal panel in response to the gate driving clock. The data driver supplies the gray scale voltage to the liquid crystal panel in response to the data driving clock. The wireless communication module may supply the address to the LCD module via a display data channel DDC.

An exemplary embodiment of the present invention provides a method for improving electromagnetic interference by changing a driving frequency. The method includes storing a communication frequency mapping table and a driving frequency mapping table, detecting a communication frequency of received data signal, supplying an address mapped to the communication frequency with reference to the communication frequency mapping table, and supplying a driving frequency mapped to the address with reference to the driving frequency mapping table.

The storing may include associating a plurality of communication frequency bands with corresponding addresses and storing the associated frequency bands and addresses. The storing may include associating the addresses with corresponding driving frequencies and storing the associated addresses and driving frequencies. The storing may include excluding a multiplying frequency of the driving frequency from the communication frequency bands. The supplying an address may include supplying an address mapped to a communication frequency band which includes the communication frequency. The method for improving electromagnetic interference by changing a driving frequency may further include generating a data driving clock and a gate driving clock by using the driving frequency.

### BRIEF DESCRIPTION OF THE DRAWINGS

The present invention will become more apparent by describing in detail exemplary embodiments thereof with reference to the accompanying drawings, in which:

FIG. 1 is a block diagram showing an LCD device according to an exemplary embodiment of the present invention;

FIG. 2 is a view showing mapping tables stored in a communication frequency memory and a driving frequency memory shown in FIG. 1;

FIG. 3 is a flow chart illustrating a method for improving electromagnetic interference by changing a driving frequency according to an exemplary embodiment of the present invention;

FIGS. 4A and 4B are graphs showing results of evaluating electromagnetic interference of an 850 MHz frequency band;

FIGS. 5A and 5B are graphs showing the results of evaluating electromagnetic interference of 900 MHz and 1900 MHz frequency bands, respectively;

FIGS. 6A and 6B are graphs illustrating a relationship between the electromagnetic interference frequency band and the driving frequency; and

FIGS. 7A and 7B are additional graphs illustrating the relationship between the electromagnetic interference frequency band and the driving frequency.

### DETAILED DESCRIPTION OF EXEMPLARY EMBODIMENTS

Hereinafter, exemplary embodiments of the present invention will be described in detail with reference to the accompanying drawings. The same reference numbers may be used throughout the drawings to refer to the same or like parts.

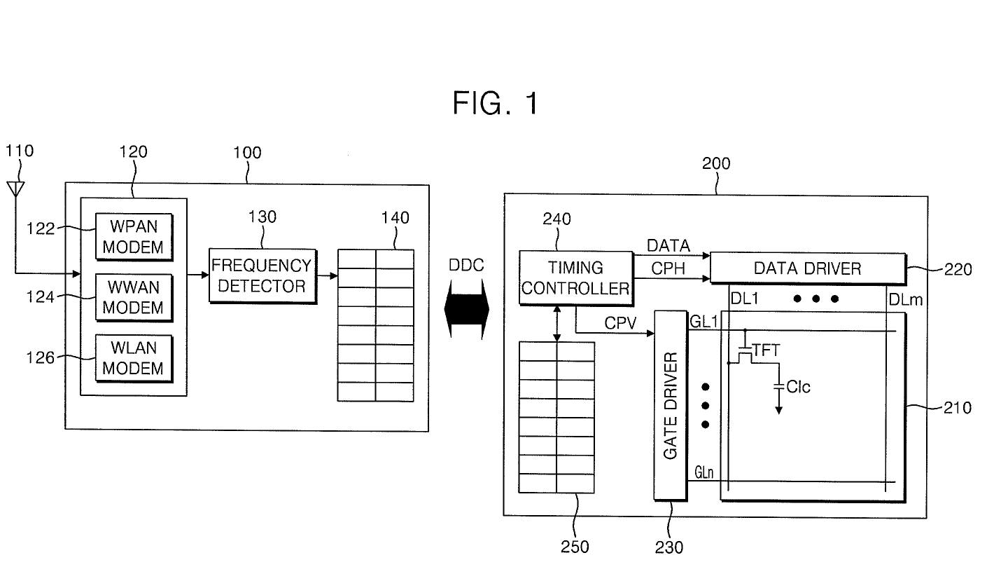

FIG. 1 is a block diagram showing an LCD device according to an exemplary embodiment of the present invention.

Referring to FIG. 1, the LCD device includes a wireless communication module 100 and an LCD module 200. The LCD device may be included with a mobile device such as a notebook computer, which displays data received/transmitted via the wireless communication module 100 on the LCD module 200.

The wireless communication module 100 performs wireless data communication according to one or more communication modes. The communication module 100 detects the frequency of a signal received via an antenna 110 and supplies an address mapped to the detected frequency to the LCD module 200. The communication modes include, for example, Code Division Multiple Access (CDMA), Global System for Mobile Communications (GSM), and Universal Mobile Telecommunications System (UMTS).

The wireless communication module 100 includes the antenna 110, a modem 120, a frequency detector 130 and a communication frequency memory 140. The antenna 110 receives a data signal from a region and supplies the data signal to the modem 120. The region may be a W-WAN region where wireless data communication service is provided by CDMA, GSM or UMTS.

The modem 120 converts the signal received from the antenna 110 into a signal that can be processed in the wireless communication module 100 and then supplies the converted signal to the frequency detector 130. For example, the modem 120 converts an analog wireless data signal into a digital data signal. The modem 120 includes the functions of a WLAN modem 126, a WWAN modem 124, and a WPAN modem 122 and is wirelessly connected to a WLAN, a WWAN, and a WPAN.

The frequency detector 130 receives the data signal from the modem 120, detects a communication frequency of the data signal, and supplies an address mapped to the communication frequency to the LCD module 200. The address is determined by referencing the communication frequency mapping table (CFMT) stored in the communication frequency memory 140. The frequency detector 130 may supply the mapped address to the LCD module 200 by using a Display Data Channel (DDC). The DDC is the plug and play standard for monitors.

The communication frequency memory 140 stores the CFMT. The CFMT is a table showing the mapping relationship between the communication frequency bands and the addresses. The communication frequency memory 140 may be an electrically erasable and programmable read only Memory (EEPROM). The EEPROM may be repeatedly erased and programmed by using a voltage higher than normal voltage.

The LCD module 200, which is a module for displaying data in images, drives a liquid crystal panel 210 by using the driving frequency mapped to the address supplied from the wireless communication module 100.

The LCD module 200 includes the liquid crystal panel 210, a data driver 220, a gate driver 230, a timing controller 240 and a driving frequency memory 250. The liquid crystal panel 210 includes an upper substrate on which a color filter is formed, a lower substrate on which a thin film transistor TFT and a liquid crystal capacitor Clc are formed, and a liquid crystal layer interposed between the upper and lower substrates. The thin film transistor TFT and liquid crystal capacitor Clc are connected to a crossing part of gate lines GL1, . . . , GLn and data lines DL1, . . . , DLm of the lower substrate. The thin film transistor TFT applies a gray scale voltage to the liquid crystal capacitor Clc in response to a gate driving signal. The gray scale voltage is an analog voltage corresponding to a data signal.

The data driver 120 generates the gray scale voltage corresponding to a data signal by using a gamma voltage, applies the gray scale voltage to the thin film transistor TFT which is driven by a gate driving signal, and displays data per gate line GL1, . . . , GLn. The data driver 120 is provided with a data synchronization clock CPH from the timing controller 240.

The gate driver 130 sequentially applies the gate driving signal to a plurality of gate lines GL1, . . . , GLn and then simultaneously turns on a plurality of thin film transistors respectively connected to the gate lines GL1, . . . , GLn. The gate driver 120 is provided with a gate synchronization clock CPV from the timing controller 240.

The gate driver 130 may be integrated in a form of an amorphous silicon gate (ASG) when the thin film transistor TFT is formed at a non-display region of the liquid crystal panel 210.

The timing controller 240 controls the data driver 220 and the gate driver 230 according to the driving frequency mapped to the address transmitted from the wireless communication module 100. The driving frequency is determined by referencing the driving frequency mapping table (DFMT) stored in the driving frequency memory 250.

The timing controller 240 generates the data synchronization clock CPH and the gate synchronization clock CPV by using the driving frequency mapped to the address. The timing controller 240 supplies the data synchronization clock CPH to the data driver 220 and the gate synchronization clock CPV to the gate driver 230.

The driving frequency memory 250 stores the DFMT. The DFMT is a table showing the mapping relationship between the addresses and the driving frequencies of the LCD module 200. The driving frequency memory 250 may be an EEPROM. The EEPROM may be repeatedly erased and programmed by using a voltage higher than normal voltage.

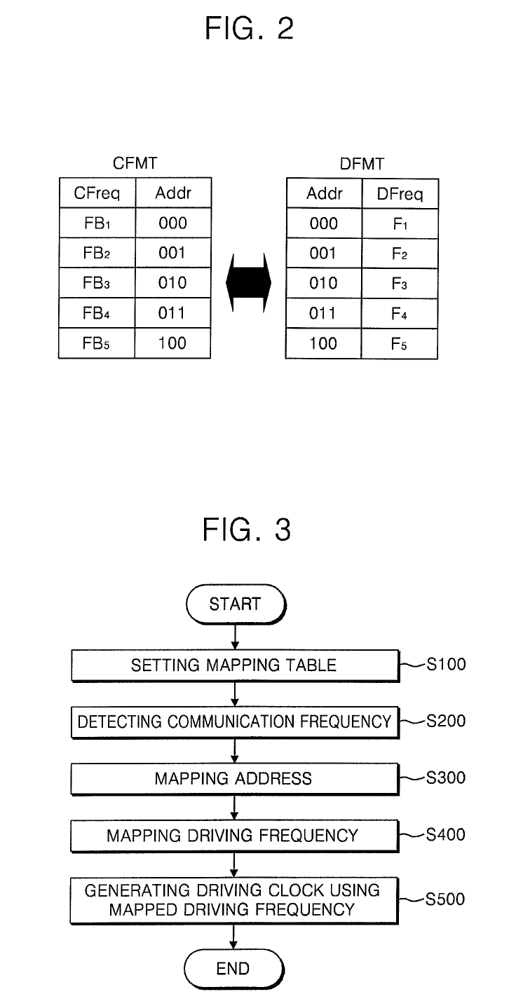

FIG. 2 is a view showing mapping tables stored in the communication frequency memory 140 and the driving frequency memory 250. Referring to FIG. 2, each entry of the CFMT includes a communication frequency band (CFreq) and an address (Addr). Each communication frequency band (CFreq) is mapped to one address (Addr). For example, the communication frequency bands (CFreq) FB₁, FB₂, FB₃, FB₄, FB₅ correspond to the addresses (Addr) 000, 001, 010, 011, 100, respectively.

In an exemplary embodiment of the present invention, the data signal can use the communication frequency in various frequency bands according to the communication mode. Table 1 displays the frequency bands of the data signal according to the communication modes.

TABLE 1

| Communication Mode | Frequency Band (MHz) |
|---|---|
| 850 CDMA | 869-894 |
| 850 GSM | 869-894 |
| 850 UMTS | 869-894 |
| 900 GSM | 925-960 |
| 1800 GSM | 1805-1880 |
| 1900 CDMA | 1930-1990 |
| 1900 GSM | 1930-1990 |
| 1900 UMTS | 1930-1990 |
| 2100 UMTS | 2110-2170 |

Referring to Table 1, the communication frequency bands (CFreq) FB1, FB2, FB3, FB4, FB5 of the CFMT may, for example, correspond to the frequency bands of 869-894 MHz, 925-960 MHz, 1805-1880 MHz, 1930-1990 MHz and 2110-2170 MHz.

Each entry in the DFMT includes an address (Addr) and a driving frequency (DFreq). Each driving frequency (DFreq) is mapped to one of the addresses (Addr). For example, the addresses (Addr) 000, 001, 010, 011, 100 may correspond to the driving frequencies (DFreq) F1, F2, F3, F4, F5, respectively. F1 may be 68.9 MHz, F2 may be 71.11 MHz, etc.

The driving frequency (DFreq) of the LCD module 200 corresponding to the communication frequency may be obtained by using the CFMT and the DFMT. When the communication frequency of the data signal received via the antenna 110 is detected, the address (Addr) mapped to the communication frequency may be obtained by referencing the CFMT and the driving frequency (DFreq) mapped to the address (Addr) may be obtained by referencing the DFMT.

FIG. 3 is a flow chart showing a method for improving electromagnetic interference by changing the driving frequency according to an exemplary embodiment of the present invention. Referring to FIG. 3, the method includes a mapping table setting step S100, a communication frequency detecting step S200, an address mapping step S300, a driving frequency mapping step S400 and a driving clock generating step S500.

In the mapping table setting step S100, the CFMT and the DFMT are stored in the communication frequency memory 140 and the driving frequency memory 250, respectively. The communication frequency memory 140 and the driving frequency memory 250 may be an EEPROM, which can store the CFMT and the DFMT by using a voltage higher than normal voltage.

In the communication frequency detecting step S200, the communication frequency of the data signal received via the antenna 110 and the modem 120 is detected.

In the address mapping step S300, the address (Addr) corresponding to the detected communication frequency is obtained by referencing the CFMT stored in the communication frequency memory 140. For example, if the detected communication frequency is within 869-894 MHz, the address 000 corresponding to the frequency band FB1 can be obtained.

In the driving frequency mapping step S400, the driving frequency (DFreq) corresponding to the address (Addr) obtained in step S300 can be obtained by referencing the DFMT stored in the driving frequency memory 250. For example, if the address (Addr) is 000, the driving frequency (DFreq) is F1, which can be, for example, 68.9 MHz corresponding to the address 000.

In the driving clock generating step S500, the data driving clock CPH and the gate driving clock CPV are generated by using a driving frequency (DFreq) that is mapped to an address (Addr). The data driving clock CPH and the gate driving clock CPV are supplied to the data driver 220 and the gate driver 230, respectively.

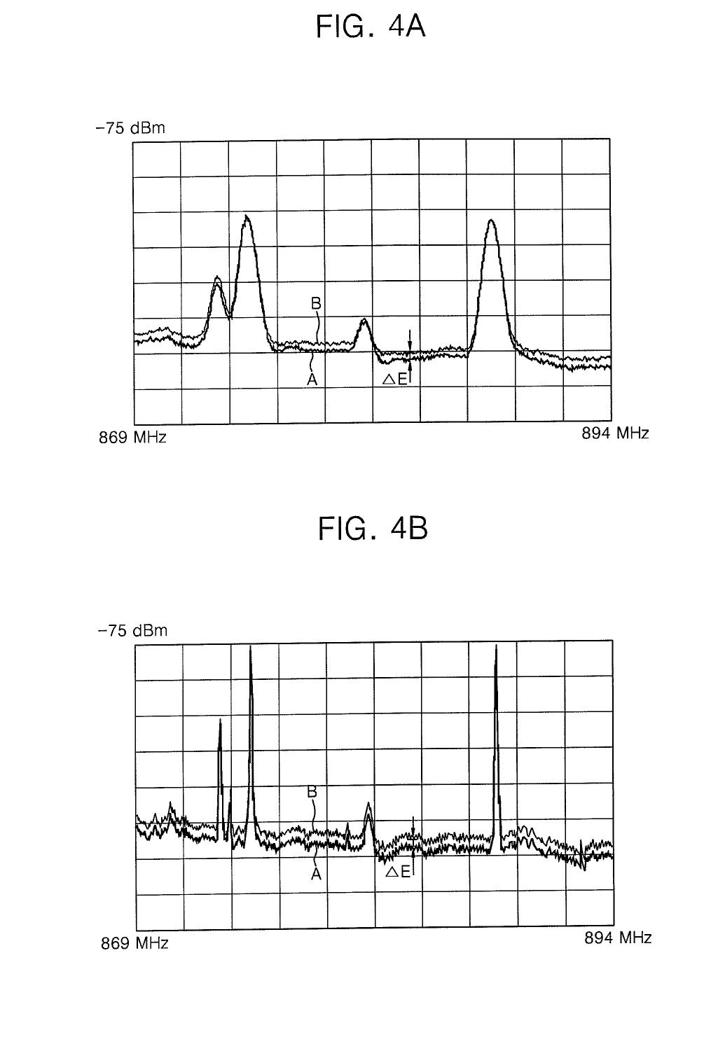

FIG. 4A is a graph illustrating changes in electromagnetic interference for different communication frequencies in a CDMA 850 communication mode, and FIG. 4B is a graph illustrating changes in electromagnetic interference for different communication frequencies in a GSM 850 communication mode. In FIGS. 4A and 4B, the curve A represents the electromagnetic interference generated at the LCD device when the LCD module 200 does not operate, and the curve B represents the electromagnetic interference generated at the LCD device when the LCD module 200 operates.

The curve A is the electromagnetic interference generated by the wireless communication module 100 itself, while the curve B is the electromagnetic interference generated by the wireless communication module 100 combined with the electromagnetic interference generated by the operation of the LCD module 200.

The distance between the curve A and the curve B is the electromagnetic interference ΔE generated by the operation of the LCD module 200. Referring to FIGS. 4A and 4B, the electromagnetic interference ΔE generated by the operation of the LCD module 200 may be within the range of about 5 dB.

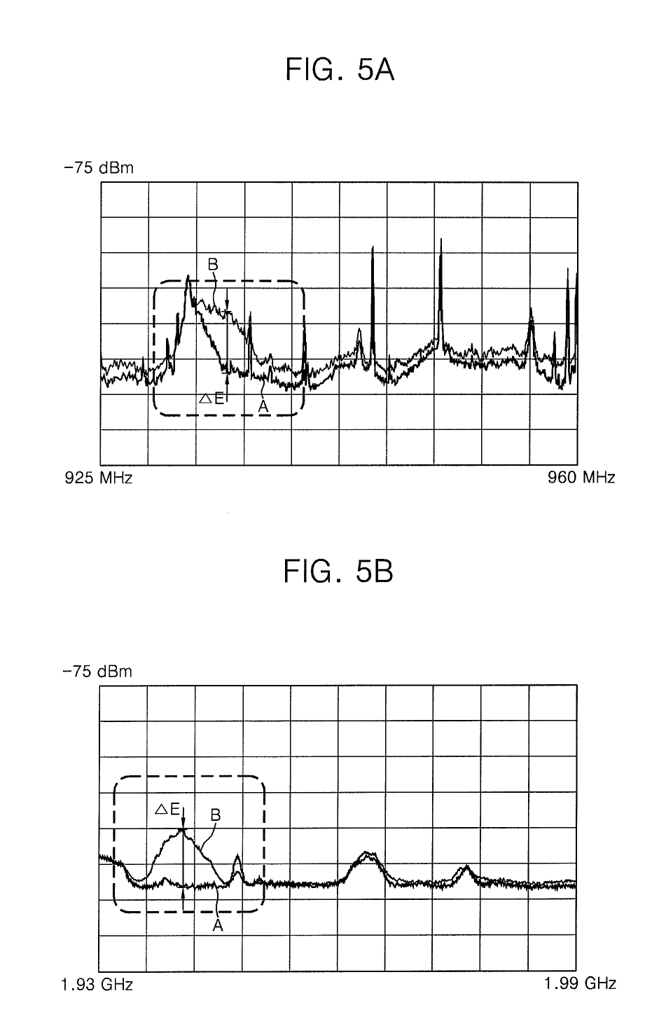

FIG. 5A is a graph illustrating changes in electromagnetic interference for different communication frequencies in a GSM 900 communication mode, and FIG. 5B is a graph illustrating changes in electromagnetic interference for different communication frequencies in a CDMA 1900 communication mode. In FIGS. 5A and 5B, the curve A represents the electromagnetic interference generated in the LCD device when the liquid crystal module 200 does not operate, and the curve B represents the electromagnetic interference generated in the LCD device when the liquid crystal module 200 operates. Referring to FIGS. 5A and 5B, the electromagnetic interference ΔE generated by the operation of the liquid crystal module 200 may exceed the range of 5 dB in a specific frequency range. The data reception/transmission of the wireless communication module 100 and the operation of the LCD module 200 may be negatively affected by electromagnetic interference ΔE that exceeds 5 dB.

Referring to FIGS. 4A, 4B, 5A and 5B, the electromagnetic interference ΔE generated by the operation of the LCD module 200 is more commonly associated with communication frequencies used in data communication such as 850 MHz, 900 MHz and 1900 MHz, rather than the particular communication mode used, such as CDMA and GSM.

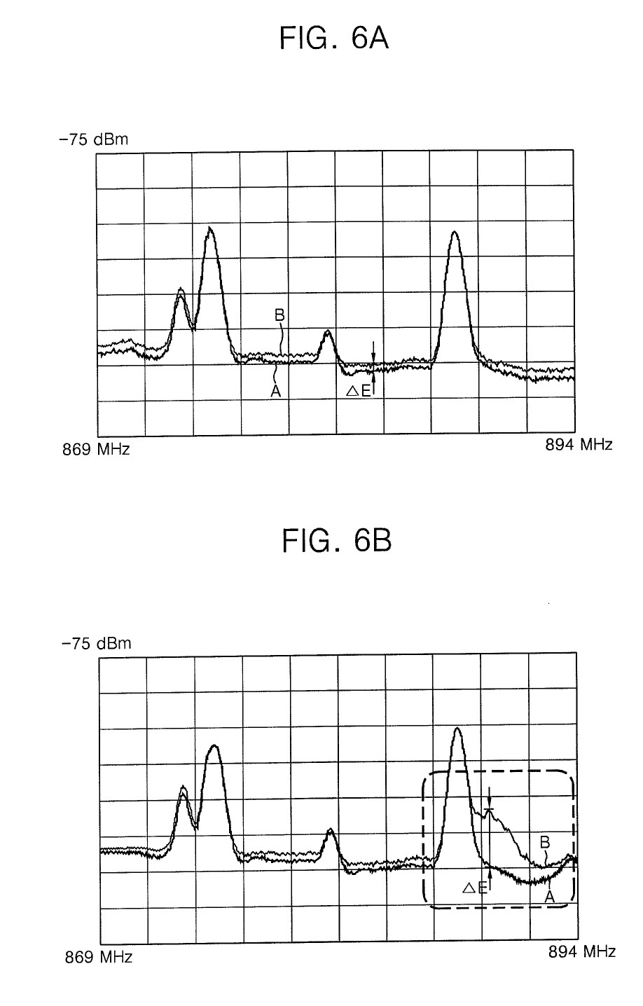

FIG. 6A is a graph illustrating changes in electromagnetic interference for different frequencies when using a CDMA 850 communication mode and a driving frequency (DFreq) of 68.9 MHz, and FIG. 6B is a graph illustrating changes in electromagnetic interference for different frequencies when using a CDMA 850 communication mode and a driving frequency (DFreq) of 71.11 MHz. In FIGS. 6A and 6B, the curve A represents the electromagnetic interference generated in the LCD device when the LCD module 200 does not operate, and the curve B represents the electromagnetic interference generated in the LCD device when the LCD module 200 operates.

Referring to FIG. 6A, the electromagnetic interference ΔE generated by the operation of the LCD module is within the range of about 5 dB. However, referring to FIG. 6B, the electromagnetic interference ΔE generated by the operation of the LCD module may exceed the range of 5 dB in a specific frequency range.

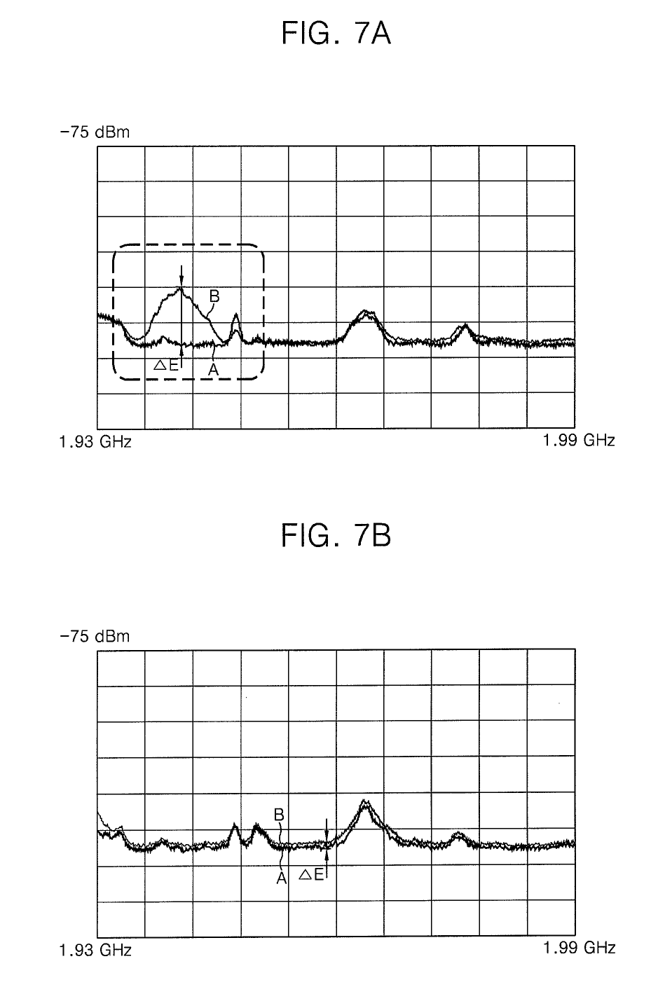

FIG. 7A is a graph illustrating changes in electromagnetic interference for different communication frequencies when using a GSM 1900 communication mode and a driving frequency (DFreq) of 68.9 MHz, and FIG. 7B is a graph illustrating changes in electromagnetic interference for different communication frequencies when using a CDMA 1900 communication mode and a driving frequency of 71.11 MHz. In FIGS. 7A and 7B, the curve A represents the electromagnetic interference generated in the LCD device when the LCD module 200 does not operate, and the curve B represents the electromagnetic interference generated in the LCD device when the LCD module 200 operates.

Referring to FIG. 7A, the electromagnetic interference ΔE generated by the operation of the LCD module 200 exceeds the range of 5 dB in a specific frequency range. However, referring to FIG. 7B, the electromagnetic interference ΔE generated by the operation of the LCD module is within the range of about 5 dB.

Referring to FIGS. 6A, 6B, 7A and 7B, the electromagnetic interference ΔE generated by the operation of the LCD module 200 can be reduced by examining the relationship between the communication frequency band (CFreq) and the driving frequency (DFreq). Referring to FIGS. 6B and 7A, where the electromagnetic interference ΔE generated by the operation of the LCD module 200 is excessive (e.g, exceeds 5 dB), the communication frequency band (CFreq) includes a multiplying frequency of the driving frequency (DFreq).

In the mapping table setting step S100, the CFMT and the DFMT may be set in such a way that the multiplying frequency of the driving frequency is not included in the communication frequency band.

According to at least one embodiment of the present invention, a method for improving electromagnetic interference by changing the driving frequency and an LCD device using same, can reduce electromagnetic interference due to the interaction of a communication frequency and the driving frequency by changing the driving frequency of an LCD module according to the communication frequency detected from a wireless communication module.

While the invention has been shown and described with reference to exemplary embodiments thereof, it will be understood by those skilled in the art that various changes in form and details may be made therein without departing from the spirit and scope of the invention.

What is claimed is:

1. A liquid crystal display device comprising:
a wireless communication module detecting a communication frequency of a received wireless data signal and supplying an address mapped to the communication frequency; and
a liquid crystal display module that includes a liquid crystal panel displaying a gray scale voltage in response to a gate driving signal and drives the liquid crystal panel by using a driving frequency mapped to the address.

2. The liquid crystal display device according to claim 1, wherein the wireless communication module comprises:
a communication frequency memory storing a communication frequency mapping table;
an antenna receiving the wireless data signal; and
a frequency detector detecting the communication frequency of the wireless data signal and supplying an address mapped to the communication frequency by referencing the communication frequency mapping table.

3. The liquid crystal display device according to claim 2, wherein the communication frequency mapping table is a table that relates a plurality of communication frequency bands to corresponding addresses.

4. The liquid crystal display device according to claim 3, wherein the communication frequency memory comprises an electrically erasable and programmable read only memory (EEPROM).

5. The liquid crystal display device according to claim 4, wherein the liquid crystal display module comprises:
a driving frequency memory storing a driving frequency mapping table; and
a timing controller obtaining the driving frequency mapped to the address by referencing the driving frequency mapping table, and generating a data driving clock and a gate driving clock by using the driving frequency.

6. The liquid crystal display device according to claim 5, wherein the driving frequency mapping table is a table which relates the addresses to corresponding driving frequencies.

7. The liquid crystal display device according to claim 6, wherein a multiplying frequency of the driving frequency is excluded from the communication frequency bands.

8. The liquid crystal display device according to claim 7, wherein the driving frequency memory comprises an EEPROM.

9. The liquid crystal display device according to claim 8, further comprising:
a gate driver supplying the gate driving signal to the liquid crystal panel in response to the gate driving clock; and
a data driver supplying the gray scale voltage to the liquid crystal panel in response to the data driving clock.

10. The liquid crystal display device according to claim 1, wherein the wireless communication module supplies the address to the liquid crystal display module via a display data channel.

11. A method for improving electromagnetic interference by changing a driving frequency, the method comprising:
storing a communication frequency mapping table and a driving frequency mapping table;
detecting a communication frequency of a received data signal;
supplying an address mapped to the communication frequency by referencing the communication frequency mapping table; and
supplying a driving frequency mapped to the address by referencing the driving frequency mapping table.

12. The method according to claim 11, wherein the storing comprises relating a plurality of communication frequency bands to corresponding addresses and storing the related communication frequency bands and addresses.

13. The method according to claim 12, wherein the storing further comprises relating the addresses to corresponding driving frequencies and storing the related addresses and driving frequencies.

14. The method according to claim 13, wherein the storing further comprises excluding a multiplying frequency of the driving frequency from the communication frequency bands.

15. The method according to claim 14, wherein the supplying an address comprises supplying an address mapped to a communication frequency band including the communication frequency.

16. The method according to claim 11, further comprising generating a data driving clock and a gate driving clock by using the driving frequency.
